(19) United States
(12) Patent Application Publication
(10) Pub. No.: US 2026/0128617 A1
(43) Pub. Date: May 7, 2026

(54) ELECTRIC POWER TRANSMISSION DEVICE, ELECTRIC POWER TRANSMISSION ANTENNA DEVICE, AND WIRELESS ELECTRIC POWER SUPPLY SYSTEM

(71) Applicant: Panasonic Intellectual Property Management Co., Ltd., Osaka (JP)

(72) Inventors: MANABU GOKAN, Hyogo (JP); YUKI TANAKA, Tokyo (JP); TAKUMA IKEDA, Osaka (JP); HIROYUKI TANI, Hyogo (JP)

(21) Appl. No.: 19/404,681

(22) Filed: Dec. 1, 2025

Related U.S. Application Data
(63) Continuation of application No. PCT/JP2024/019974, filed on May 31, 2024.

(30) Foreign Application Priority Data
Jun. 6, 2023 (JP) 2023-093249

(51) Int. Cl. H02J 50/20; H02J 50/40; H02J 50/80

(52) U.S. Cl. CPC H02J 50/20; H02J 50/402; H02J 50/80

(57) ABSTRACT

An electric power transmission device includes: an oscillator that outputs an AC signal; a controller that outputs a control signal; and a modulator that modulates an AC signal output from the oscillator in response to the control signal. The control signal is a signal for selecting an antenna that radiates the AC signal from among a plurality of antennas.

### TECHNICAL FIELD

The present disclosure relates to an electric power transmission device, an electric power transmission antenna device, and a wireless electric power supply system.

### BACKGROUND ART

Currently, a wireless electric power supply technology for the Internet of Things (IoT) is being studied for practical use. In a wireless electric power supply technology, radio waves radiated from an electric power transmission antenna of an electric power transmission device are received by an electric power reception antenna of an electric power reception device, a value of electric power of the received radio waves is observed in real time, and information of the observed electric power is fed back to the electric power transmission device, thereby electric power of the radio waves to be received can be maintained at a necessary and sufficient magnitude.

As a wireless electric power supply system, there is a system that controls a plurality of antennas included in an electric power transmission device to form beams and wirelessly supplies electric power to electric power reception devices (see, for example, PTL 1). FIG. 8 is a diagram illustrating a wireless electric power supply system 800 described in PTL 1.

In PTL 1, wireless electric power supply system 800 includes electric power transmission device 810 and electric power reception unit 820. Electric power transmission device 810 includes a plurality of antennas 811 and a plurality of antenna cables 812, and wirelessly supplies electric power to electric power reception unit 820. Electric power transmission device 810 transmits radio waves including an electric power signal to the electric power reception devices of electric power reception unit 820, and transmits radio waves not including an electric power signal to the transmitting-receiving device of electric power reception unit 820. In wireless electric power supply system 800, electric power transmission device 810 controls the directionality with the plurality of antennas 811 connected to the plurality of antenna cables 812, thereby simultaneously transmitting electric power and information to the plurality of electric power reception units 820.

### CITATION LIST

### Patent Literature

PTL 1: Unexamined Japanese Patent Publication No. 2023-005766

### SUMMARY OF THE INVENTION

An electric power transmission device in an exemplary embodiment of the present disclosure includes: an oscillator that outputs an AC signal; a controller that outputs a control signal; and a modulator that modulates an AC signal output from the oscillator in response to the control signal, in which the control signal is a signal for selecting an antenna that radiates the AC signal from among a plurality of antennas.

An electric power transmission antenna device in an exemplary embodiment of the present disclosure includes: a plurality of antennas, each of which radiates an AC signal; and a controller that selects an antenna that radiates an AC signal from among the plurality of antennas based on a control signal included in the AC signal, in which the AC signal is modulated in response to the control signal.

### BRIEF DESCRIPTION OF THE DRAWINGS

FIG. 1 is a diagram illustrating a system configuration of a wireless electric power supply system in a first exemplary embodiment.

FIG. 2A is a diagram illustrating envelopes of microwaves output from an electric power transmission device.

FIG. 2B is a diagram illustrating electric power transmission times and electric power transmission pause times of microwaves in the first exemplary embodiment.

FIG. 3 is a flowchart illustrating a procedure of processing executed by the electric power transmission device.

FIG. 4 is a flowchart illustrating a procedure of processing executed by an electric power transmission antenna device.

FIG. 5 is a flowchart illustrating a procedure of processing executed by an electric power reception device.

FIG. 6 is a sequence diagram illustrating a procedure of processing performed by the wireless electric power supply system in the first exemplary embodiment.

FIG. 7 is a diagram illustrating a system configuration of a wireless electric power supply system in a second exemplary embodiment.

FIG. 8 is a diagram illustrating a wireless electric power supply system described in PTL 1.

### DESCRIPTION OF EMBODIMENT

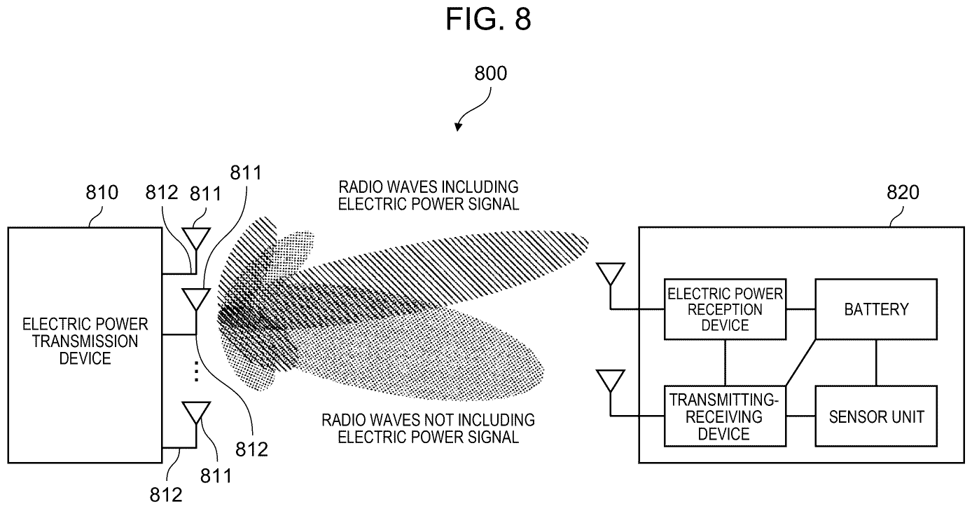

In the configuration of FIG. 8, the efficiency of electric power transmission may be reduced due to the influence of the installation location of electric power reception unit 820, such as electric power reception unit 820 being disposed at a location where metal is present in the periphery, or the influence of the orientation of the antenna of electric power reception unit 820.

The present disclosure has been made to solve the above problems, and an object of the present disclosure is to provide a wireless electric power supply system that improves electric power transmission efficiency.

### First Exemplary Embodiment

Hereinafter, exemplary embodiments will be described with reference to the drawings.

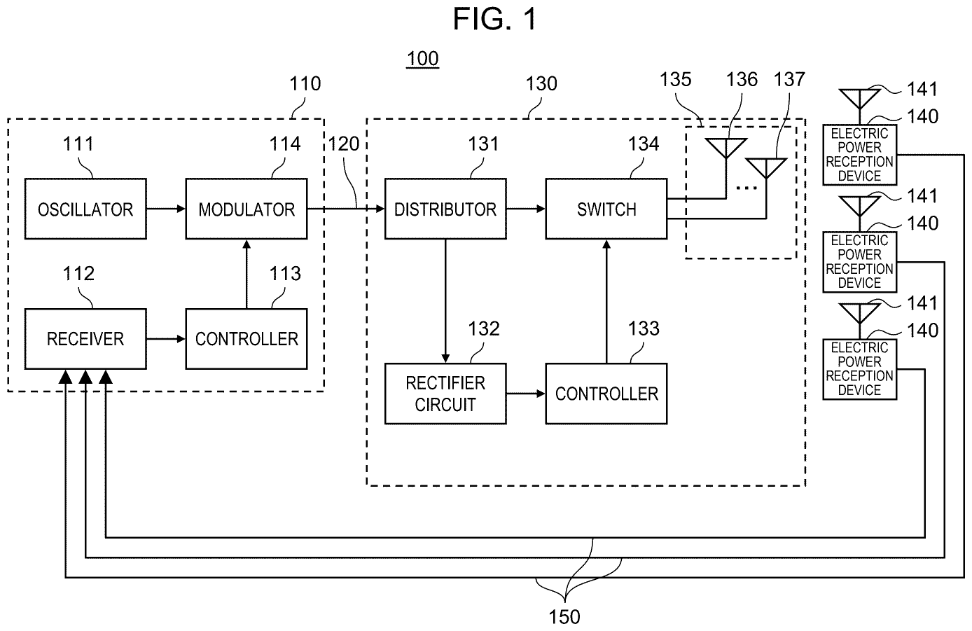

FIG. 1 is a diagram illustrating a system configuration of wireless electric power supply system 100 in a first exemplary embodiment.

In FIG. 1, wireless electric power supply system 100 includes electric power transmission device 110, electric power transmission antenna cable 120, electric power transmission antenna device 130, and electric power reception devices 140.

Electric power transmission device 110 includes oscillator 111, receiver 112, controller 113, and modulator 114.

Oscillator 111 oscillates an AC signal and outputs an AC signal with electric power of 1 W, for example. The AC signal is, for example, a microwave in a 920 MHz band, but may be an AC signal of another frequency.

Receiver 112 receives information on the received electric power from electric power reception device 140.

Controller 113 determines whether the received electric power is larger than the target electric power, and outputs a control signal to modulator 114 when the received electric power is less than the target electric power. The control signal is a control signal for switching the antenna that radiates the AC signal in electric power transmission antenna device 130.

Modulator 114 modulates the AC signal received from oscillator 111 with the control signal received from controller 113. Modulator 114 performs modulation by, for example, amplitude shift keying (ASK), on off keying (OOK), or pulse width modulation (PWM). Modulator 114 can also use other modulation methods.

Electric power transmission antenna cable 120 transmits a signal output from electric power transmission device 110 to electric power transmission antenna device 130. Electric power transmission antenna cable 120 is, for example, a coaxial cable having an impedance of 50 Ω, but a cable having another impedance may be used.

Electric power transmission antenna device 130 includes distributor 131, rectifier circuit 132, controller 133, switch 134, and multiple antenna unit 135.

For example, distributor 131 transmits 99% of the power of 1 W output from electric power transmission device 110 to switch 134, and transmits 1% of the power to rectifier circuit 132. Distributor 131 is configured with, for example, a directional coupler, a Wilkinson coupler, or a hybrid circuit, but another distribution circuit may be used.

Rectifier circuit 132 converts the AC signal output from distributor 131 into a DC signal. Rectifier circuit 132 is configured with, for example, a voltage doubler rectifier circuit, a current doubler rectifier circuit, a cross coupled rectifier circuit, a single-shunt rectifier circuit, or a single-series rectifier circuit, but other rectifier circuits may be used. The signal converted into the DC signal by rectifier circuit 132 is transmitted to controller 133.

Controller 133 generates a control signal for controlling switch 134. Controller 133 demodulates the DC signal received from rectifier circuit 132, extracts a control signal such as a command, and outputs the extracted control signal to switch 134. The DC signal received from rectifier circuit 132 is modulated by, for example, ASK, OOK, or PWM. Note that other modulation methods may be used. The control signal is a signal such as a command or a timer code.

Switch 134 selects antenna 136 or antenna 137 from among the antennas constituting multiple antenna unit 135 in accordance with the control signal generated by controller 133. Switch 134 includes, for example, a PIN diode switch, a monolithic microwave integrated circuit (MMIC), a micro electro mechanical systems (MEMS), and a relay. When multiple antenna unit 135 includes three or more antennas, switch 134 may select one antenna or a plurality of antennas.

Multiple antenna unit 135 includes antenna 136 and antenna 137. In the present exemplary embodiment, the multiple antenna unit includes two antennas, but may include three or more antennas. Antennas 136 and 137 include, for example, at least one of a vertical polarization antenna that outputs vertically polarized waves and a horizontal polarization antenna that outputs horizontally polarized waves. Antennas 136 and 137 may be composed of other antennas such as a horizontal polarization antenna, an orthogonal polarization antenna, a circular polarization antenna, a dipole antenna, a monopole antenna, and a patch antenna.

Multiple antenna unit 135 performs polarization switching, beam switching, spatial diversity, and the like. The antenna selected from the antennas included in multiple antenna unit 135 radiates, for example, 99% of the power output from electric power transmission device 110, into space as radio waves.

Electric power reception devices 140 each include electric power reception antenna 141.

Electric power reception antennas 141 receive the radiated radio waves. Although each electric power reception device 140 has only one antenna illustrated in FIG. 1, electric power reception device 140 may have a plurality of antennas, or may have a plurality of antennas from the viewpoint of use environment and optimization. Electric power reception device 140 includes, for example, a rectifier circuit that converts a radio waves received by electric power reception antenna 141 into a direct current, a storage battery, various sensors, a communication circuit, and a power measurement circuit that measures or estimates received electric power.

The communication circuit of each electric power reception device 140 transmits the value of the received electric power measured or estimated by the power measurement circuit and the data measured by the various sensors to electric power transmission device 110 through communication line 150. The communication circuit can use a circuit such as Bluetooth low energy (BLE) or backscatter communication. The circuit in electric power reception device 140 is driven by the electric power of the radio waves received by electric power reception antenna 141.

The various sensors may be sensors that measure temperature, humidity, acceleration, and a remaining amount of the storage battery. There may be one or more sensors.

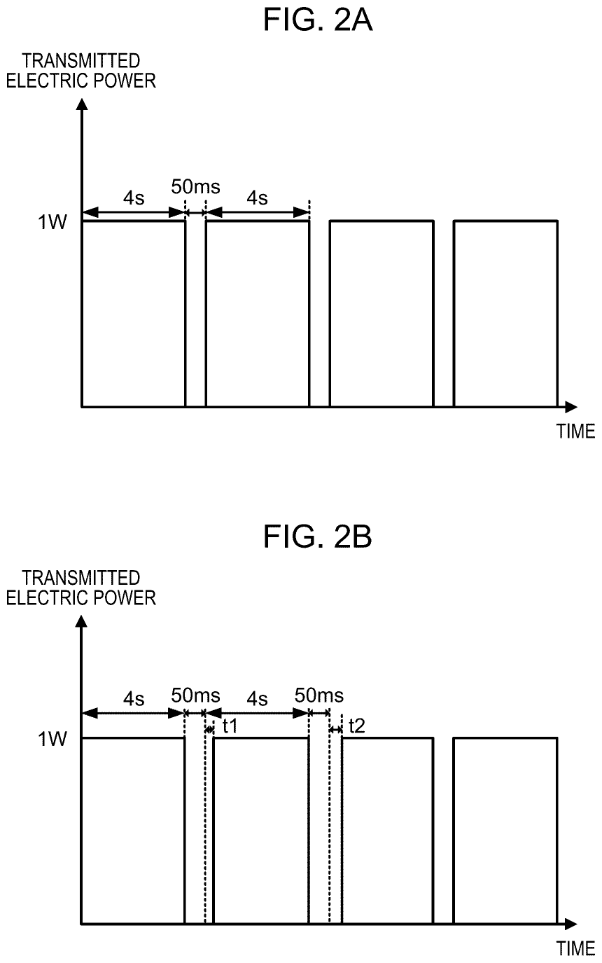

FIG. 2A is a diagram illustrating envelopes of microwaves output from electric power transmission device 110.

In Japan, laws and regulations related to the Radio Law Enforcement Regulations and the like have been revised in 2022, and the electric power transmission time and the electric power transmission pause time have been determined. According to the laws and regulations, the electric power transmission time is defined to be within 4 s, and the electric power transmission pause time is defined to be 50 ms or more. Electric power transmission device 110 generates microwaves to be output to electric power transmission antenna device 130 within a range satisfying this condition. Note that the present exemplary embodiment is applicable not only to Japan but also to a case where radio waves are transmitted in a form of repeating electric power transmission and electric power transmission pause.

FIG. 2B is a diagram illustrating a microwave electric power transmission time and a microwave electric power transmission pause time in the first exemplary embodiment.

Electric power transmission device 110 generates a modulation signal by, for example, PWM for an electric power transmission time within 4 s. Specifically, electric power transmission device 110 generates a modulation signal by changing the length of the electric power transmission time of the AC signal in response to the control signal to be superimposed.

For example, electric power transmission device 110 does not change the electric power transmission time of 4 s when transmitting “0”, and shortens the electric power transmission time by 1 ms and lengthens the electric power transmission pause time by 1 ms when transmitting “1”. Since the time to shorten is 1 ms for the electric power transmission time 4 s, the loss is as small as 1/4000. In addition, when transmitting “0”, electric power transmission device 110 may shorten the electric power transmission time by 2 ms and lengthen the electric power transmission pause time by 2 ms. The change in the electric power transmission time may be a time other than 1 ms.

In the case of modulation by ASK, the electric power of the microwave transmitted in response to the signal to be superimposed may be changed to, for example, 1 W or 0.9 W. In the case of modulation by OOK, the transmission or non-transmission of the microwave in the electric power transmission time may be changed in response to the signal to be superimposed. The modulation may be performed by both PWM and ASK.

In FIG. 2B, the start of the electric power transmission time is delayed in response to the signal to be superimposed, but the end of the electric power transmission time may be advanced in response to the signal to be superimposed.

As described above, since 1-bit information can be transmitted for one electric power transmission time, in a case where 16 antennas are connected, it is possible to transmit a command designating an antenna to be used by using four electric power transmission times.

Here, “1” may be transmitted when the antenna to be used is changed, and “0” may be transmitted when the antenna to be used is not changed. The antenna to be used may be changed to any antenna, or an antenna in a next predetermined order may be used. It may also be possible that only when the antenna to be used is changed, the antenna to be used is designated by the control signal, and when the antenna to be used is not changed, the control signal is not transmitted.

The amount of information transmitted in one electric power transmission time does not need to be one bit. For example, two-bit information may be transmitted in one electric power transmission time by selecting an electric power transmission time to be changed from four options: t0 to t3. One bit of the 2 bits may be used as a control signal for electric power transmission antenna device 130, and the remaining 1 bit may be used as information for electric power reception devices 140. A control signal for electric power transmission antenna device 130 and information for electric power reception devices 140 may be transmitted in a time-division manner.

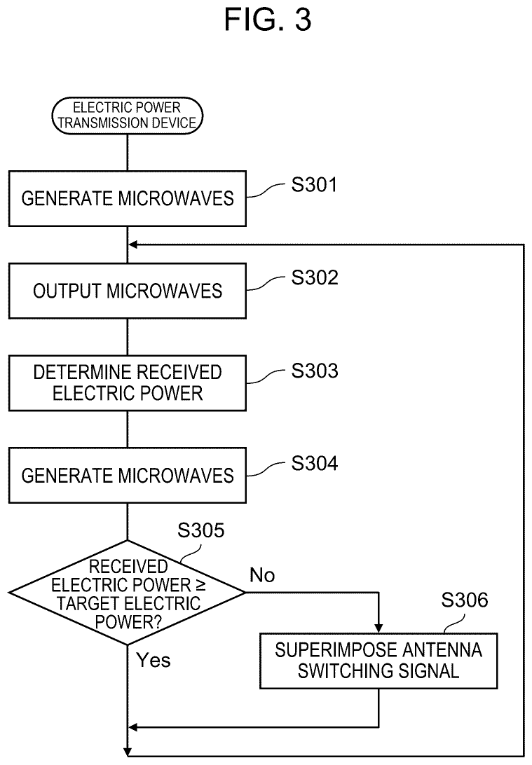

FIG. 3 is a flowchart illustrating a procedure of processing executed by electric power transmission device 110.

Oscillator 111 of electric power transmission device 110 generates microwaves (step S301). Note that oscillator 111 may generate an AC signal having a frequency other than the microwaves.

Then, modulator 114 outputs the microwaves generated by oscillator 111 to electric power transmission antenna cable 120 (step S302).

Thereafter, receiver 112 receives information on the received electric power from electric power reception devices 140 (step S303). For the reception from the reception device, BLE, backscatter communication, or the like is used. Note that other communication means may be used. In addition, receiver 112 may receive information other than the received electric power from electric power reception devices 140.

Subsequently, oscillator 111 generates microwaves (step S304). The microwaves generated in step S304 are microwaves transmitted in one electric power transmission time after the microwaves generated in step S301.

Then, controller 113 determines whether the received electric power received in S303 is higher than or equal to the target electric power (step S305).

When the received electric power is less than the target electric power (step S305, No), the switching of the antenna is performed. Therefore, modulator 114 superimposes a control signal for switching the antenna on the microwaves generated in step S304 (step S306).

For superimposition of the control signal, for example, the above-described PWM can be used. The control signal for switching the antenna may be a command for designating an antenna to be used, a command for instructing to use any antenna different from the current antenna, or a command for instructing to use an antenna in a next predetermined order.

When the received electric power is higher than or equal to the target electric power (step S305, Yes), it is not necessary to switch the antenna, so that modulator 114 does not superimpose the control signal on the microwaves generated in step S304. Note that modulator 114 may superimpose a command indicating that the same antenna as the previous antenna is used, or may superimpose a command designating the same antenna as the previous antenna.

Modulator 114 outputs the signal on which the control signal is superimposed in step S306 or the microwaves generated in step S304 on which the control signal is not superimposed to electric power transmission antenna cable 120 (step S302).

Repeating steps S302 to S306 allows electric power transmission device 110 to transmit electric power larger than the target electric power to electric power reception devices 140. Therefore, the control signal for switching the antenna described above is a signal for selecting an antenna so that the received electric power of electric power reception device 140 becomes higher than or equal to the target electric power.

Note that, after step S301, an antenna switching signal may be superimposed that designates an antenna in the initial state in electric power transmission antenna device 130.

Note that electric power transmission device 110 may receive information on whether the received electric power is higher than or equal to the target electric power in step S303, and determine, in step S305, whether the received electric power of the signal received in step S303 is higher than or equal to the target electric power.

In addition, electric power transmission device 110 may determine whether the total received electric power of the electric power reception devices 140 is larger than the target electric power, or may determine whether the received electric power of electric power reception device 140 that is the transmission target is larger than the target electric power.

Furthermore, electric power transmission device 110 may receive, from each electric power reception device 140, information on the status of the storage battery included in electric power reception device 140. Then, electric power transmission device 110 may determine electric power reception device 140 to which electric power is transmitted depending on the status of the storage battery of each electric power reception device 140. For example, electric power transmission device 110 may transmit power to electric power reception device 140 including a storage battery having a small storage amount.

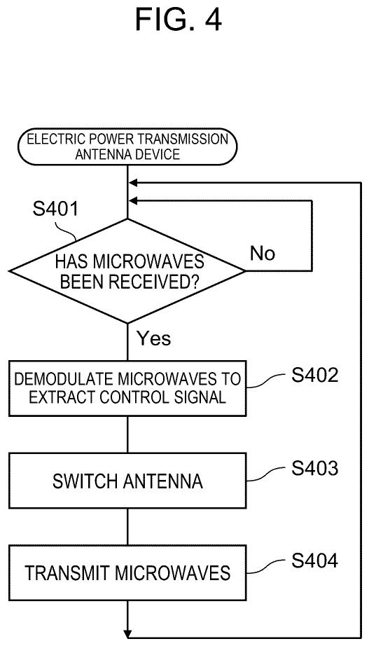

FIG. 4 is a flowchart illustrating a procedure of processing executed by electric power transmission antenna device 130.

Controller 133 of electric power transmission antenna device 130 determines whether it has received microwaves from electric power transmission antenna cable 120 (step S401). When electric power transmission antenna device 130 has not received the microwaves, the process returns to step S401 and waits for reception of the microwaves. The AC signal to be received may be a signal other than the microwaves.

Then, controller 133 demodulates the received microwave to extract a control signal (step S402).

Subsequently, controller 133 performs antenna switching control in accordance with the extracted control signal (step S403).

Electric power transmission antenna device 130 radiates microwaves from the antenna switched by switch 134 (step S404).

After the microwave is radiated, the process returns to step S401 and waits for reception of the microwave.

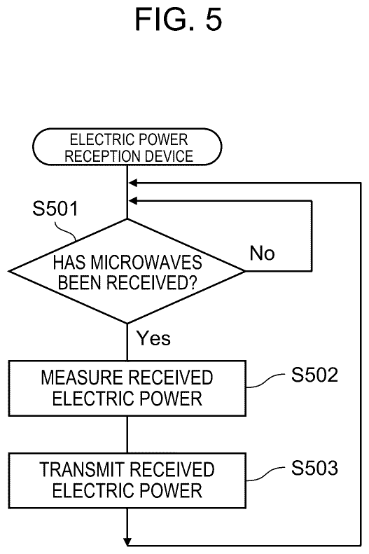

FIG. 5 is a flowchart illustrating a procedure of processing executed by each electric power reception device 140. The processing illustrated in the flowchart is executed by a control device (not illustrated) in electric power reception device 140.

Electric power reception device 140 determines whether it has received microwaves (step S501). When electric power reception device 140 has not received the microwaves, the process returns to step S501 and waits for reception of the microwaves. The received radio wave may be a radio wave other than a microwave.

Electric power reception device 140 measures the received electric power of the received microwaves (step S502).

Electric power reception device 140 transmits information on the measured received electric power to electric power transmission device 110 (step S503). For transmission to electric power transmission device 110, BLE, backscatter communication, or the like is used. Note that other communication means may be used. In addition, electric power reception device 140 may transmit information on the status of the storage battery of electric power reception device 140 to electric power transmission device 110.

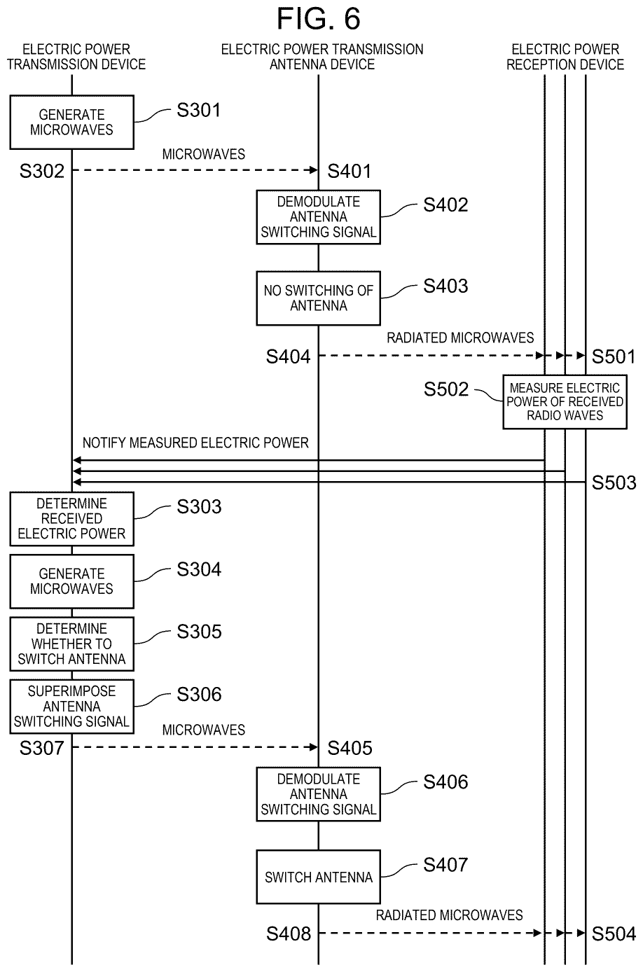

FIG. 6 is a sequence diagram illustrating a procedure of processing performed by wireless electric power supply system 100 according to the first exemplary embodiment.

The processing of steps S301 to S306 in FIG. 6 corresponds to the processing of steps S301 to S306 in FIG. 3, and the processing of step S307 in FIG. 6 corresponds to the processing of step S302 in FIG. 3.

The processing of steps S401 to S404 in FIG. 6 corresponds to the processing of steps S401 to S404 in FIG. 4, and the processing of steps S405 to S408 in FIG. 6 corresponds to the processing of steps S401 to S404 in FIG. 4.

The processing of steps S501 to S503 in FIG. 6 corresponds to the processing of steps S501 to S503 in FIG. 5, and the processing of step S504 in FIG. 6 corresponds to the processing of step S501 in FIG. 5.

Electric power transmission device 110 generates microwaves (step S301).

Electric power transmission device 110 outputs the generated microwave to electric power transmission antenna device 130 (step S302).

Electric power transmission antenna device 130 receives the microwaves output from the electric power transmission device 110 (step S401).

Electric power transmission antenna device 130 demodulates the antenna switching signal from the received microwaves (step S402). For example, a 4-bit antenna switching signal is superimposed using four pulses.

In this case, step S401 is the first reception, the antenna switching signal is not superimposed, and the switching of the antenna is not performed (step S403).

Electric power transmission antenna device 130 radiates the microwaves received from the electric power transmission device 110 (step S404).

Each electric power reception device 140 receives the microwaves radiated by electric power transmission antenna device 130 (step S501).

Each electric power reception device 140 measures the electric power of the received microwaves (step S502).

Each electric power reception device 140 notifies electric power transmission device 110 of the measured microwave electric power (step S503).

Electric power transmission device 110 determines the electric power of the microwaves received from each electric power reception device 140, and determines whether the electric power is larger than the target electric power (step S303).

Electric power transmission device 110 generates a microwaves to be transmitted at the next timing (step S304).

Electric power transmission device 110 determines whether to switch the antenna based on the result of the determination in step S303 (step S305).

When determining to switch the antenna, electric power transmission device 110 superimposes the antenna switching signal. In this case, since it is determined that the switching of the antenna is performed, the antenna switching signal is superimposed (step S306). For example, by superimposing the antenna switching signal on each pulse by one bit, the 4-bit antenna switching signal is superimposed using four pulses.

Electric power transmission device 110 outputs the microwaves on which the antenna switching signal is superimposed to electric power transmission antenna device 130 (step S307). The microwave output in step S307 is the second processing of step S302 returned after step S305 or step S306 in FIG. 3.

Electric power transmission antenna device 130 receives the microwaves output from the electric power transmission device 110 (step S405). The microwave reception in step S405 is the second processing of step S401 returned after step S404 in FIG. 4.

Electric power transmission antenna device 130 demodulates the antenna switching signal from the received microwaves (step S406). For example, an antenna switching signal is superimposed on each pulse by one bit, and four pulses can demodulate a four-bit antenna switching signal. The processing of step S406 is the second processing of step S402 in FIG. 4.

Electric power transmission antenna device 130 switches the antenna based on the antenna switching signal (step S407). The switching of the antenna in step S407 is the second processing of step S403 in FIG. 4.

Electric power transmission antenna device 130 radiates the microwaves received from electric power transmission device 110 by the switched antenna (step S408). The microwave radiation in step S408 is the second processing of step S404 in FIG. 4.

Each electric power reception device 140 receives the radiated microwaves (step S504). The microwave reception in step S504 is the second processing of step S501 returned after step S503 in FIG. 5.

In FIG. 6, the antenna switching signal may be superimposed after step S301, and then the microwaves may be output in step S302. The antenna switching signal in this case may be a signal that designates an antenna in the initial state, or may be a signal indicating that switching is not performed.

According to such a configuration, electric power transmission device 110 and electric power transmission antenna device 130 are connected by single electric power transmission antenna cable 120. This can eliminate the influence of noise due to extra wiring, and prevent deterioration of construction efficiency. In addition, since an optimum antenna can be selected by switching the antenna, electric power transmission efficiency can be increased.

### Second Exemplary Embodiment

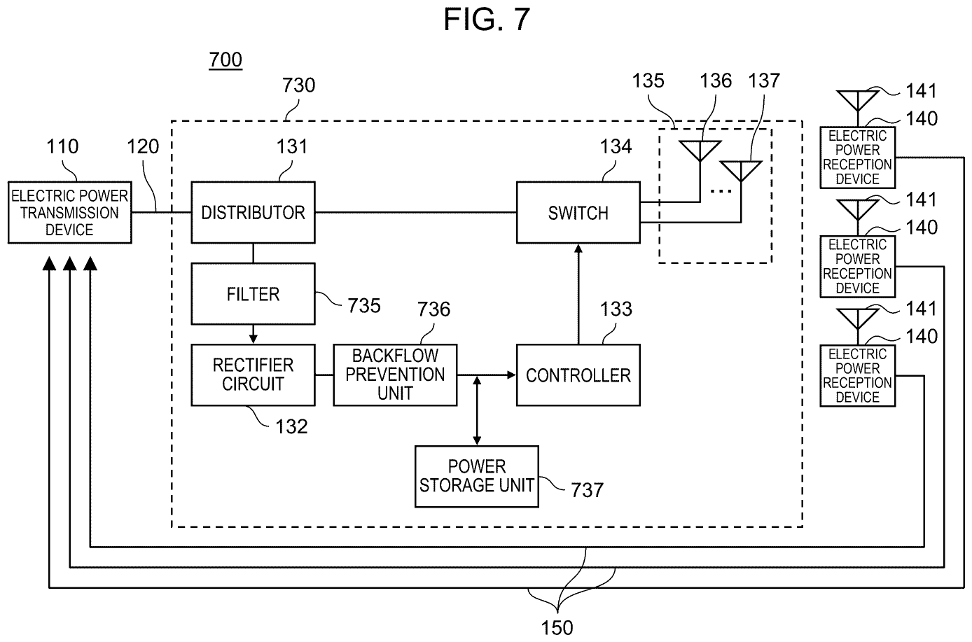

FIG. 7 is a diagram illustrating a system configuration of wireless electric power supply system 700 according to a second exemplary embodiment. In FIG. 7, the same components as those in FIG. 1 are denoted by the same reference numerals, and description thereof is omitted.

In FIG. 7, electric power transmission antenna device 730 includes distributor 131, filter 735, rectifier circuit 132, backflow prevention unit 736, power storage unit 737, controller 133, switch 134, and multiple antenna unit 135. Hereinafter, only filter 735, backflow prevention unit 736, and power storage unit 737 that are not present in FIG. 1 will be described.

Filter 735 is a circuit that reduces noise when noise is superimposed on the AC signal distributed by distributor 131. Noise is generally harmonic noise, but other noise is also present. For filter 735, for example, a low pass filter (LPF), a band pass filter (BPF), a high pass filter (HPF), or a band elimination filter (BEF) is used depending on noise. As a result, an AC signal with reduced noise is transmitted to rectifier circuit 132. Also in the first exemplary embodiment, a filter may be positioned between distributor 131 and rectifier circuit 132.

Backflow prevention unit 736 prevents backflow of the electric power stored in power storage unit 737 into rectifier circuit 132. Backflow prevention unit 736 is configured with a diode or the like.

Power storage unit 737 stores the electric power of the DC signal output from rectifier circuit 132, and provides electric power for driving the circuit inside electric power transmission antenna device 730 during the electric power transmission pause time. Power storage unit 737 is configured with a capacitance, a lithium ion battery, a nickel hydrogen battery, a flywheel, or the like, but may store power by other means.

As described above, wireless electric power supply system 700 includes electric power transmission device 110, single electric power transmission antenna cable 120, electric power transmission antenna device 730, and electric power reception devices 140 each including electric power reception antenna 141. Electric power transmission antenna device 730 includes distributor 131 that distributes electric power to electric power for power transmission and electric power for control, rectifier circuit 132 that converts the power for control into DC power, the controller that demodulates the control signal from the DC power, switch 134 that selects a plurality of antennas in accordance with the control signal, filter 735 that reduces harmonic noise, power storage unit 737 that stores the DC power, and backflow prevention unit 736 that prevents backflow of electric power from power storage unit 737. Electric power transmission antenna device 730 switches to the selected antenna to transmit the electric power.

This eliminates need for connecting electric power transmission device 110 and the plurality of antennas through a plurality of coaxial cables and a plurality of control signal lines, making it possible to perform the operation even during the electric power transmission pause time, and to reduce loss of the plurality of coaxial cables and deterioration of construction efficiency.

Although the exemplary embodiments have been described with reference to the accompanying drawings, the present disclosure is not limited to the examples. It is apparent that those skilled in the art could easily conceive of various changes or modifications within the scope of the claims. Such changes or modifications are also understood to belong to the technical scope of the present disclosure. In addition, within a range without departing from the gist of the present disclosure, the components in the exemplary embodiments may be combined as appropriate.

(1) A wireless electric power supply system in an exemplary embodiment of the present disclosure includes: an electric power transmission device that generates an AC signal; an electric power transmission antenna device that receives the AC signal from the electric power transmission device and radiates the AC signal from an antenna; a single electric power transmission antenna cable that connects the electric power transmission device and the electric power transmission antenna device; and an electric power reception device that receives the AC signal, in which the electric power transmission antenna device includes: a multiple antenna unit including a plurality of antennas that radiate the AC signal; a switch that selects an antenna that radiates the AC signal from among the plurality of antennas of the multiple antenna unit; and a controller that controls the switch, and the controller demodulates a control signal for controlling the switch from the AC signal, and selects an antenna that radiates the AC signal based on the control signal.

(2) In the wireless electric power supply system of (1), the electric power transmission antenna device further includes: a distributor that distributes the AC signal received from the electric power transmission device; a filter that reduces noise of the AC signal distributed by the distributor; a rectifier circuit that rectifies the AC signal with the noise that has been reduced into a DC signal; a power storage unit that stores electric power of the DC signal; and a backflow prevention unit that prevents backflow of the electric power from the power storage unit to the rectifier circuit.

(3) In the wireless electric power supply system of (1), the electric power transmission device changes a length of an electric power transmission time of the AC signal in response to the control signal.

(4) In the wireless electric power supply system of (1), the plurality of antennas include at least one of a vertical polarization antenna that outputs vertically polarized waves and a horizontal polarization antenna that outputs horizontally polarized waves.

(5) In the wireless electric power supply system of (1), the control signal is a signal for selecting an antenna so as to maximize received electric power of the electric power reception device.

(6) In the wireless electric power supply system of (1), the electric power transmission antenna cable is a coaxial cable.

(7) An electric power transmission antenna device in an exemplary embodiment of the present disclosure is an electric power transmission antenna device that receives an AC signal from the electric power transmission device connected to the electric power transmission antenna device through one electric power transmission antenna cable and transmits the AC signal to an electric power reception device, and the electric power transmission antenna device includes: a multiple antenna unit including a plurality of antennas that radiate the AC signal; a switch that selects an antenna that radiates the AC signal from among the plurality of antennas of the multiple antenna unit; and a controller that controls the switch, in which the controller demodulates a control signal for controlling the switch from the AC signal, and selects an antenna that radiates the AC signal based on the control signal.

(8) An electric power transmission device in an exemplary embodiment of the present disclosure is an electric power transmission device that transmits an AC signal to an electric power transmission antenna device including a plurality of antennas for transmitting an AC signal to an electric power reception device, and the electric power transmission device includes: an oscillator that outputs an AC signal; and a modulator that modulates the AC signal output from the oscillator in response to a control signal for selecting an antenna of the electric power transmission antenna device, and the electric power transmission device is connected to the electric power transmission antenna device through a single electric power transmission antenna cable.

As described above, according to the wireless electric power supply system of the present disclosure, electric power can be stably received without impairing the efficiency of electric power transmission, and construction efficiency can be improved.

### INDUSTRIAL APPLICABILITY

The wireless electric power supply system of the present disclosure can stably receive electric power without impairing the electric power transmission efficiency, makes it possible to simplify the system configuration and reduce the cost, and is applicable to an application of stabilizing the received electric power of the electric power reception device in wireless electric power transmission.

### REFERENCE MARKS IN THE DRAWINGS

100, 700, 800: wireless electric power supply system
110, 810: electric power transmission device
111: oscillator
112: receiver
113, 133: controller
114: modulator
120: electric power transmission antenna cable
130, 730: electric power transmission antenna device
131: distributor
132: rectifier circuit
134: switch
135: multiple antenna unit
136, 137, 811: antenna
140: electric power reception device
141: electric power reception antenna
150: communication line
735: filter
736: backflow prevention unit
737: power storage unit
812: antenna cable
820: electric power reception unit

1. An electric power transmission device comprising:
an oscillator that outputs an AC signal;
a controller that outputs a control signal; and
a modulator that modulates an AC signal output from the oscillator in response to the control signal,
wherein the control signal is a signal for selecting an antenna that radiates the AC signal from among a plurality of antennas.

2. The electric power transmission device according to claim 1, wherein
in response to the control signal, the modulator
(i) changes a length of an electric power transmission time of the AC signal and a length of an electric power transmission pause time of the AC signal,
(ii) changes electric power of the AC signal, or
(iii) changes transmission and non-transmission of the AC signal in an electric power transmission time of the AC signal.

3. The electric power transmission device according to claim 1, further comprising a receiver that receives information indicating received electric power from an electric power reception device that has received the AC signal,
wherein the controller outputs the control signal when the received electric power is less than target electric power.

4. An electric power transmission antenna device comprising:
a plurality of antennas, each of which radiates an AC signal; and
a controller that selects an antenna that radiates an AC signal from among the plurality of antennas based on a control signal included in the AC signal,
wherein the AC signal is modulated in response to the control signal.

5. The electric power transmission antenna device according to claim 4, wherein
in response to the control signal, the AC signal
(i) is changed in a length of an electric power transmission time of the AC signal and a length of an electric power transmission pause time of the AC signal,
(ii) is changed in an electric power of the AC signal, or
(iii) is changed in transmission and non-transmission of the AC signal in an electric power transmission time of the AC signal.

6. The electric power transmission antenna device according to claim 4, further comprising a rectifier circuit that converts the AC signal into a DC signal,
wherein the controller demodulates the control signal from the DC signal.

7. The electric power transmission antenna device according to claim 4, further comprising a switch that selects an antenna that radiates the AC signal,
wherein the controller controls the switch based on the control signal.

8. The electric power transmission antenna device according to claim 4, wherein
the plurality of antennas include at least one of a vertical polarization antenna that outputs vertically polarized waves and a horizontal polarization antenna that outputs horizontally polarized waves.

9. The electric power transmission antenna device according to claim 4, further comprising:
a distributor that distributes the AC signal;
a filter that reduces noise of the AC signal distributed by the distributor;
a rectifier circuit that rectifies an AC signal with the noise that has been reduced into a DC signal;
a power storage unit that stores electric power of the DC signal; and
a backflow prevention unit that prevents backflow of the electric power from the power storage unit to the rectifier circuit.

10. A wireless electric power supply system, comprising:
the electric power transmission device according to claim 1; and
a single electric power transmission antenna cable that connects the electric power transmission device and the electric power transmission antenna device.

11. The wireless electric power supply system according to claim 10, wherein the single electric power transmission antenna cable is a coaxial cable.
